(19) United States
(12) Patent Application Publication
(10) Pub. No.: US 2003/0083040 A1
(43) Pub. Date: May 1, 2003

(54) Method of logging call processing information in a mobile communication network

(76) Inventors: Todd Ruth, Valley Center, CA (US); Philip Cochran, Poway, CA (US)

Correspondence Address: COATS & BENNETT, PLLC, P O BOX 5, RALEIGH, NC, 27602, US

(21) Appl. No.: 10/000,644

(22) Filed: Nov. 1, 2001

(51) Int. Cl. H04M 11/00

(52) U.S. Cl. 455/405; 455/560; 455/551

(57) ABSTRACT

A method for logging call information associated with a representative sampling of calls in a mobile communication network is disclosed. An identifier associated with each call is hashed to generate a hash value. The hash value is compared to predetermined logging criteria to determine whether call information associated with a particular call should be logged. Call information is logged for those calls meeting the predetermined criteria. The present invention may be used standing alone or to supplement IMSI-based call logging procedures already implemented in mobile communication networks.

### BACKGROUND OF THE INVENTION

The present invention relates generally to a method of monitoring system performance in a mobile communication network and, more particularly, to a method of logging detailed call processing information associated with a representative sampling of system users.

System operators often need to log information concerning calls to monitor network performance, to collect status information, and to diagnose problems in a communication network. For example, if the communication network is experiencing a large number of failures, such as dropped calls, it is helpful to log detailed information on calls in order to diagnose the problem. Also, system operators often collect status information to gauge network performance by counting every single event for every call and aggregating and processing the numbers to calculate performance statistics. It is impractical to log detailed call information for all calls, due to the resulting increase in system overhead and the volume of information that would be generated. Logging detailed call information during off-peak hours, such as at night, is possible but may not be representative of calls made during peak hours.

It is desirable to log detailed information for a representative sampling of calls. Such a sampling can be used to determine statistics of network performance and to diagnose problems that arise. Obtaining a representative sampling, however, is not a trivial task since call processing in a communication network is distributed among many different entities. Each network entity should, preferably, log information concerning the same calls to provide a complete picture of what is happening at each stage in call processing. Therefore, coordinating the logging activity among the various network entities becomes a significant problem.

One method currently in use to log call information is to distribute a table to the various network entities involved in call logging that contains the IMSI or other identifier for selected mobile terminals whose calls are to be logged. Since signaling messages associated with call processing include the IMSI of the mobile terminal served by the call, the various network entities can use the IMSI to determine which calls to log. By comparing the IMSI in received signaling messages to the values contained in the stored IMSI table, the network entity is able to determine which calls to include in its call log.

The prior art method of logging detailed call information based on the IMSI of the mobile terminal is not without drawbacks. First, the network must select valid IMSIs to include in the IMSI table and distribute the IMSI table to the various network entities involved in call logging. Depending upon the size of the IMSI table, this could take significant time and consume significant system overhead. Second, in order to vary the percentage of calls being logged, a new IMSI table would need to be generated and distributed to the processing entities involved in call logging. Third, the network entities involved in call logging must compare the IMSI extracted from signaling messages to each individual IMSI in the IMSI table in order to determine whether to log information related to that call. This could produce undesirable delays in call processing, particularly if the IMSI table is large. If the IMSI table is used to log test phones that are owned by the service provider and driven along test routes, the IMSI table may be small, but the data collected often is not representative of actual users.

Accordingly, there is a need for a method of logging call information for a representative sampling of calls which is easy to implement in existing networks and minimizes system overhead.

### SUMMARY OF THE INVENTION

The present invention relates to a method and apparatus for logging call information for a representative sampling of calls in a mobile communication network. To determine which calls to enter into a call information log, an identifier associated with the call, such as a mobile terminal identifier (e.g., IMSI) or call identifier (e.g., call ID), is hashed to generate a hash value. The resulting hash value is compared to predetermined criteria to determine whether to log call information for that particular call. The criteria used to determine whether to log a call should, preferably, be chosen to minimize delays and the burden on system resources and memory. By way of example, the central network management entity or processing entities could be programmed to log call information for all calls where the hash value is less than a predetermined number, greater than a predetermined number, equal to a predetermined number, or within a predetermined range. Other criteria could also be used. If the hash value meets the predetermined criteria, selected call information concerning that particular call is logged.

Logging of call information may be performed by a central processor entity within a base station controller, or may be distributed among a plurality of processing entities that perform various call processing functions. To avoid repeatedly rehashing the identifier each time a call processing function is performed, either the central processor or individual processing entities can “remember” which calls to log by storing an identifier associated with a call in memory once it is determined that a particular call should be logged. Identifiers stored in memory would, in that case, be deleted once the call is terminated to enable reuse of the identifier in subsequent calls. The identifier stored in memory may be the same identifier used to generate the hash value, or may comprise a different identifier. For example, the central processor or individual processing entities could generate a hash value based on a mobile terminal identifier and, once it is determined that a particular call should be logged, a store a call identifier associated with that call in memory.

### BRIEF DESCRIPTION OF THE DRAWINGS

FIG. 1 is a functional block diagram of an exemplary mobile communication system.

FIG. 2 is a functional block diagram of a base station controller according to one embodiment of the present invention.

FIGS. 3a and 3b illustrate how to use an existing IMSI table to implement the present invention.

FIG. 4 is a flow diagram of the call logging procedure according to the present invention.

FIG. 5 is a flow diagram of an alternative call logging procedure according to the present invention.

### DETAILED DESCRIPTION OF THE INVENTION

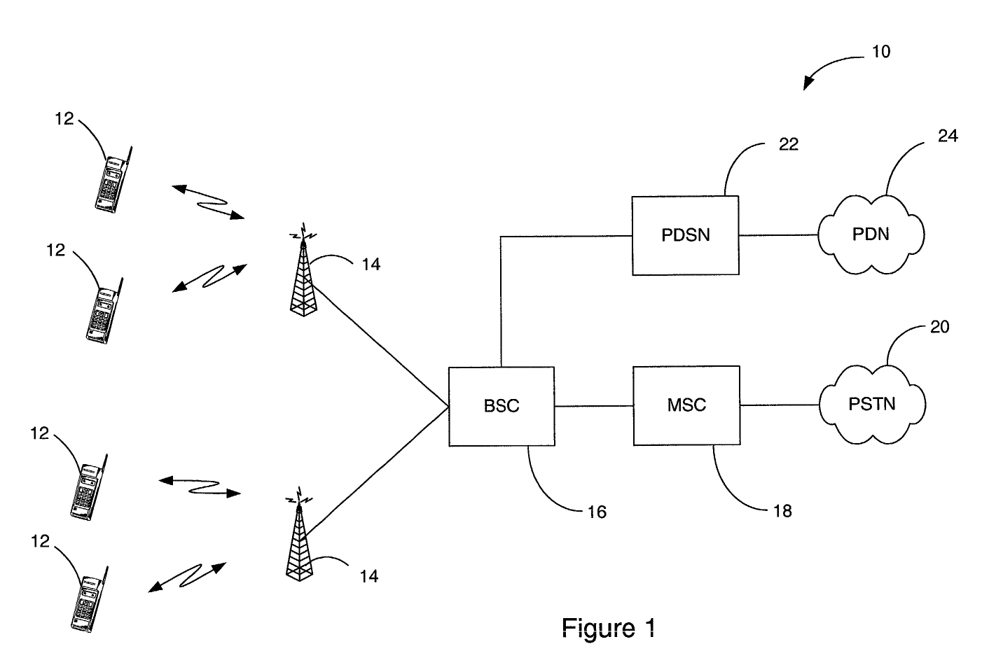

Referring now to the drawings, FIG. 1 illustrates the logical architecture of an exemplary mobile communication network, which is indicated generally by the numeral 10. The logical architecture does not imply any particular physical implementation but illustrates the logical relationship among network components that support mobile communications. The following description is intended to describe how to implement the present invention in an exemplary mobile communication system. Those skilled in the art will recognize that the present invention can be adapted for use in mobile communication systems employing different standards.

The mobile communication network 10 comprises a plurality of mobile terminals 12, a plurality of base transceiver stations (BTSs) 14, one or more base station controllers (BSCs) 16, one or more mobile switching centers (MSCs) 18, and one or more packet data serving nodes (PDSNs) 22. The mobile terminals 12 communicate over a radio frequency channel with a serving BTS 14 and may be handed-off to a number of different BTSs 14 during a call. Each BTS 14 is located in, and provides service to a geographic region. The BTS 14 comprises a plurality of transmitters and receivers and can simultaneously handle many different calls. The BTS 14 connects to a BSC 16, which manages the RF resources for a plurality of BTSs 14. The BSC 16 connects via a telephone line or microwave link to the MSC 18. The MSC 18 coordinates the operations of the BSCs 16 and BTSs 14, and connects the mobile communication network 10 to public networks, such as the Public Switched Telephone Network (PSTN) 20. The MSC 16 routes calls to and from the mobile terminals 12 through the appropriate BTS 14 and coordinates handoffs as the mobile terminal 12 moves from one cell within the mobile communication network 10 to another cell. The mobile communication network 10 of FIG. 1 further comprises a PDSN 22 for providing packet data services to mobile terminals 12. PDSN 22 functions as a gateway for connecting mobile terminals 12 to the PDN 24.

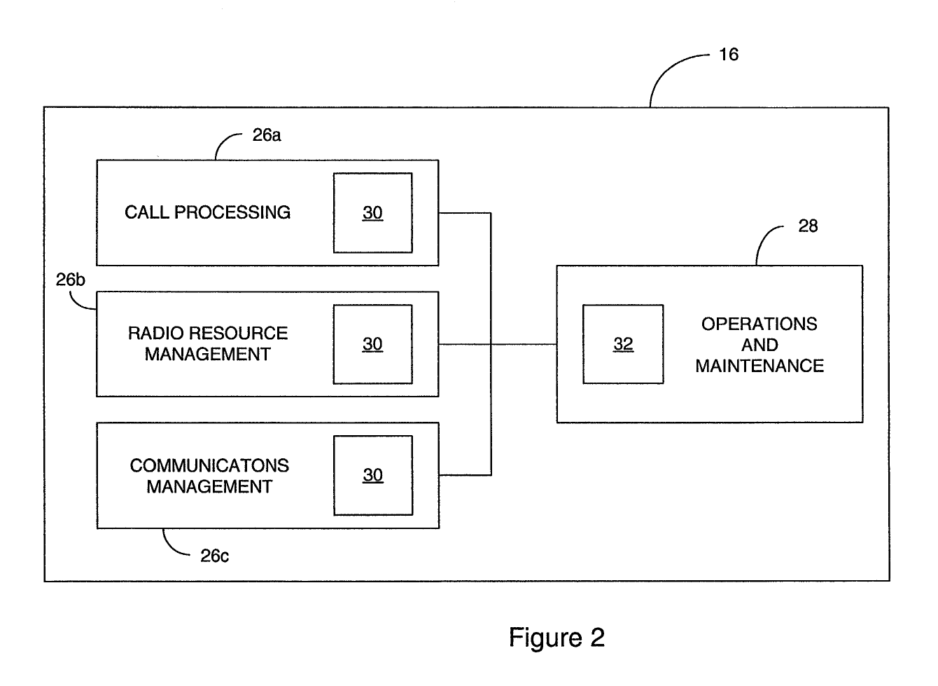

FIG. 2 is a block diagram of the BSC 16 showing some of the logical entities within the BSC 16. As is well known in the art, the processing functions of the BSC 16 are distributed among numerous processing entities 26. Each processing entity 26 may comprise one or more processors to perform the functions assigned to that processing entity 26. The processing entities 26 within the BSC 16 include call processing 26a, radio resource management 26b, and communications management 26c. Other processing entities may also exist. The call processing (CP) entity 26a performs call control functions, such as call establishment and call release. The radio resource management (RRM) entity 26b manages the radio resources used in a call. It allocates radio resources to a call and manages hand-offs. The communications management (CM) entity 26c manages communications with the MSC 18, PDSN 22, and other network components. The type and number of processing entities 26 may vary depending on the equipment manufacturer and the communication standards being employed. The BSC 16 may further include a central operations and maintenance module (OMM) 28 to perform certain maintenance functions. Of particular relevance to the present invention, the OMM 28 may log call information for diagnosing problems and testing network performance.

Selected processing entities 26 are responsible for logging call information, such as signaling messages received or transmitted by that processing entity 26, status information (e.g., system load or utilization), or user data. Logging may be triggered by a number of different events, such as the receipt or transmission of a signaling message, the expiration of a timer, or the detection of a predetermined condition (e.g., an error). Logging is often not desired for all calls, but instead is desired only for a representative sampling of the calls. Since the functionality of the BSC 16 is distributed among many different processing entities 26, coordinating logging by all of the processing entities 26 is problematic. Preferably, each processing entity 26 in the BSC 16 involved in call logging should log information for the same calls. The present invention provides a method of logging call information based upon an identifier associated with the call, such as the IMSI or call ID, which is known to each of the processing entities 26 involved in logging calls.

The present invention may be implemented, for example, as an IMSI based call logging procedure. IMSI-based call logging procedures are known. These known IMSI based call logging procedures log call information based on the IMSI of the mobile terminal 12 served by a call. This allows the processing entities 26 to log call information for selected mobile terminals 12 only, which are specified by IMSIs. In the past, IMSI based call logging was achieved by storing a table containing a list of IMSIs to use in call logging. The IMSI table had to be distributed, or otherwise accessible, to each processing entity 26 involved in call logging. When a logging event occurred (e.g., receiving or sending a signaling message), the processing entity 26 would compare the IMSI for the mobile terminal 12 served by the call to the entries in the IMSI table stored in memory. If the IMSI of the served mobile terminal 12 matched an entry in the stored IMSI table, the processing entity 26 logged the required information. This method required the processing entity 26 to compare the IMSI of the served mobile terminal 12 with each entry in the IMSI table one-by-one. If the IMSI table is large, this process could consume significant processing and memory resources and delay call processing, which is undesirable. This method also required the system operator to know which IMSI would be making a call. This usually resulted in logging only test phones that were known to be placing calls in a specific area.

Rather than comparing the IMSI of the mobile terminal 12 served by a call with a list of values, the present invention uses a hash function to generate a hash value corresponding to the IMSI and logs the call information if the hash value meets a predetermined logging criteria. For example, suppose that a hash function was chosen such that any value input to the hash function hashes to an integer between 0 and 1023−a total of 1024 possible values. The system operator could select a desired percentage of calls to log by selecting a single hash value. If the system operator desires to log 5% of all calls, for example, the processing entities 26 within the BSC 16 would be programmed to log call information for all calls where the IMSI of the mobile terminal 12 hashes to a value less than or equal to 52 (53 values being logged/1024 possible values =5.17% of calls). Thus, the processing entities 26 can determine which calls to log based on a single comparison, rather than the hundreds or thousands of comparisons required by the prior art method. This logging criteria (i.e., less than a specified number) allows logging of a fixed percentage of calls between x% and 100% in increments of x, where x is the reciprocal of the number of possible hash values.

Numerous variations of the logging method of the present invention are possible by simply changing the logging criteria. For example, the processing entities 26 could be instructed to log call information for all calls where the hash value is greater than a specified value, equal to a specified value, or between two specified values. By changing the logging criteria over time, the processing entities 26 could cycle through all possible hash values so there is at least an opportunity to log call information for all mobile terminals 12, though not at the same time. For example, a sliding range that changes periodically could be specified that results in 5% of the calls being logged during any given time interval. In this case, a different 5% would be selected in each successive time interval until the processing entities 26 cycle through all possible hash values. One hash functions suitable for use with the present invention is the multiplicative hash method described in KNUTH, THE ART OF COMPUTER PROGRAMMING, Vol. 3, Ch. 6.4 (1998), which is incorporated herein by reference. As described by Knuth, the hash value h(K) of a given value K is determined by the following equation:

$$h ( K ) = ⌊ M ( ( \frac{A}{w} K ) mod 1 ) ⌋ \qquad \text{Eq. (1)}$$

where w is the word size of the computer, A is an integer constant that is relatively prime to w, and M is a power of 2. This hash function, referred to herein as the Knuth algorithm, should preferably be uncorrelated with the hashing values specified by the IS/95/2000 standard for paging channels and frequency assignments to avoid any unintended correlation between call logging hash values and air interface hash values. In the hash functions implemented in the IS/95/2000 standard, the fraction A/w approximates the golden ratio. Therefore, when hashing an IMSI using the same formal: as that of the standard, a different irrational number, such as the decimal part of the square root of seven, could be used in the present invention to avoid unintended correlation.

The logging function may be implemented in a central OMM 28 in the BSC 16 as shown in FIG. 2. In this implementation, each processing entity 26 includes a code module 30 for notifying the OMM 28 when a logging event occurs and for providing the required information to the OMM 28. The OMM 28 includes a code module 32 to perform call logging. The code module 32 in the OMM 28 decides whether to enter call information associated with the event into the log by hashing the IMSI of the mobile terminal 12 served by the call and applying the logging criteria to the result. If the hash value meets the logging criteria, the desired call information is entered into the log. If not, the call information provided by the processing entity 26 is discarded.

Those skilled in the art will appreciate that the call logging function does not necessarily need to be centralized and that a separate OMM 28 could be eliminated. Instead, the logging function could be distributed among the processing entities 26. Each processing entity 26 could, for example, include the equivalent functions of code module 32 for determining whether to log call information and for logging the required call information. The various processing entities 26 could maintain a separate log, or alternatively, log call information into a shared table to which each processing entity 26 has access.

The present invention can be implemented easily in existing networks that already implement IMSI based call logging. Such networks already include code for logging call information based on the IMSI of the mobile terminal 12 being served by a call. As previously described, these existing systems perform call logging by comparing the IMSI of the mobile terminal 12 served by a call to a plurality of IMSIs stored in a table. The operation may involve hundreds or thousands of comparisons. The present invention can be implemented in such existing networks by storing the logging criteria in the IMSI table along with any specified IMSIs.

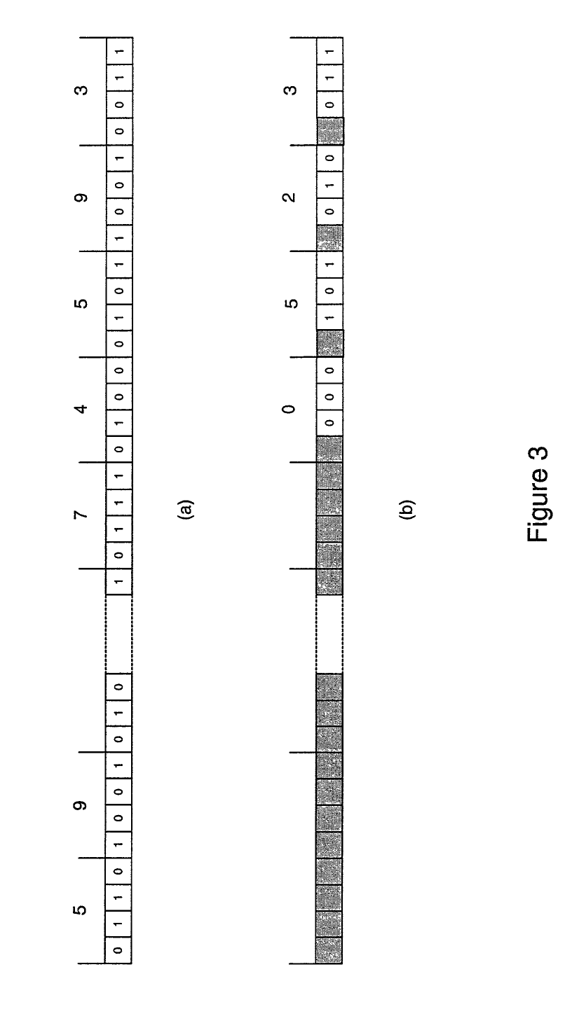

FIG. 3 is a flow diagram illustrating how to use an existing IMSI table to implement the present invention. The IMSI is an 8 byte number which is stored in BCD format in the IMSI table as seen in FIG. 3a. The logging criteria used in the present invention is, in comparison, typically in the order of 2 bytes in length. The logging criteria may be stored using the 16 least significant bits of the IMSI table in either octal format as shown in FIG. 3b or in BCD format. When using either octal format or BCD format, all bits in the third through eighth bytes are blanked on entries corresponding to a hash value. When octal format is used, the fourth and eighth bits of the first two bytes are also blanked as seen in FIG. 3b. The processing entity 26 can readily distinguish the logging criteria from an actual IMSI stored in the same table based on the size of the entry. That is, the logging criteria (e.g., hash value) will be smaller than actual IMSIs stored in the same table. Using this method, the processing entity 26 can still perform call logging based on both actual IMSIs as was done in the prior art. The present invention could thus be used to supplement or replace currently employed logging schemes.

When practicing the present invention, it is not necessary to repeatedly hash the IMSI contained in every signaling message received or sent by the processing entities 26. Instead, the OMM 28 or processing entities 26 can “remember” which calls to log after it is determined for the first time that a particular call is to be logged. For example, when a call is initially set-up, a call ID is assigned to that call to distinguish it from other calls. The processing entities 26 or OMM 28 can hash the IMSI of the mobile terminal 12 served by the call or the call ID to determine whether call information related to that particular call should be logged. After making this determination, the OMM 28 or processing entities 26 can remember the call ID associated the call. The call IDs for all calls being logged can be stored in one or more tables in memory and used to determine whether to log call information for a particular call in response to a logging event. The number of calls being logged at any given time is likely to be small. Therefore, the call ID table will be much smaller than an IMSI-only table populated to log the same percentage of calls. The logging procedure would in this case include a procedure to delete entries from the call ID table when a call is terminated.

If call logging is distributed among a plurality of processing entities 26, the processing entity 26 that processes the origination request can determine whether that call is to be logged and notify other processing entities 26 involved in call logging by, for example, sending the call ID to the other processing entities. Thus, it is not necessary for every processing entity 26 involved in call logging to hash the identifier.

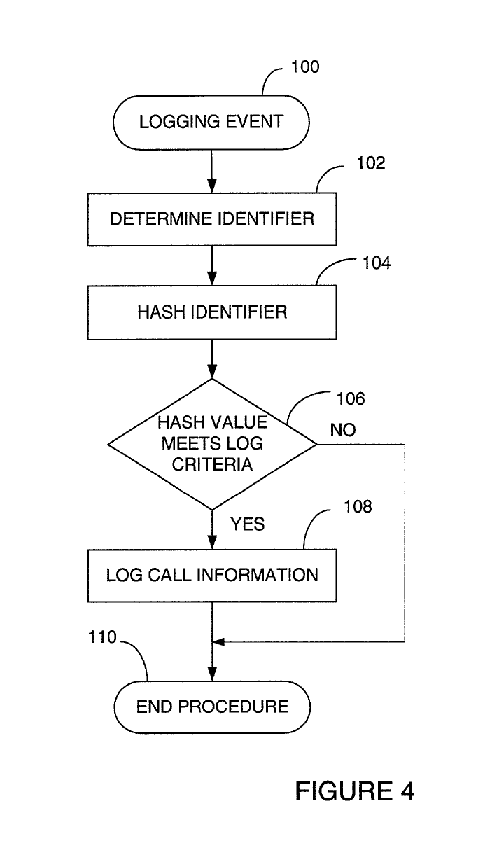

FIG. 4 is a flow diagram illustrating an exemplary call logging procedure of the present invention. The call logging procedure shown in FIG. 4 is invoked when a logging event occurs (block 100), such as the receipt of a signaling message or other event that requires call processing. The system operator can choose what types of events to log and the processing entity 26 is programmed to recognize those events. If the event is a type that must be logged, the processing entity 26 determines the IMSI of the mobile terminal associated with the call and hashes the IMSI (steps 102 and 104). At step 106, the processing entity 26 applies the predetermined comparison criteria to the generated hash value to determine whether to log call information associated with the event being processed. If the predetermined criteria are met, the processing entity 26 enters the required call information into the log (step 108) and the procedure ends (step 110 ). If the generated hash value does not meet the predetermined criteria, the procedure ends (step 110) without entering any information into the log.

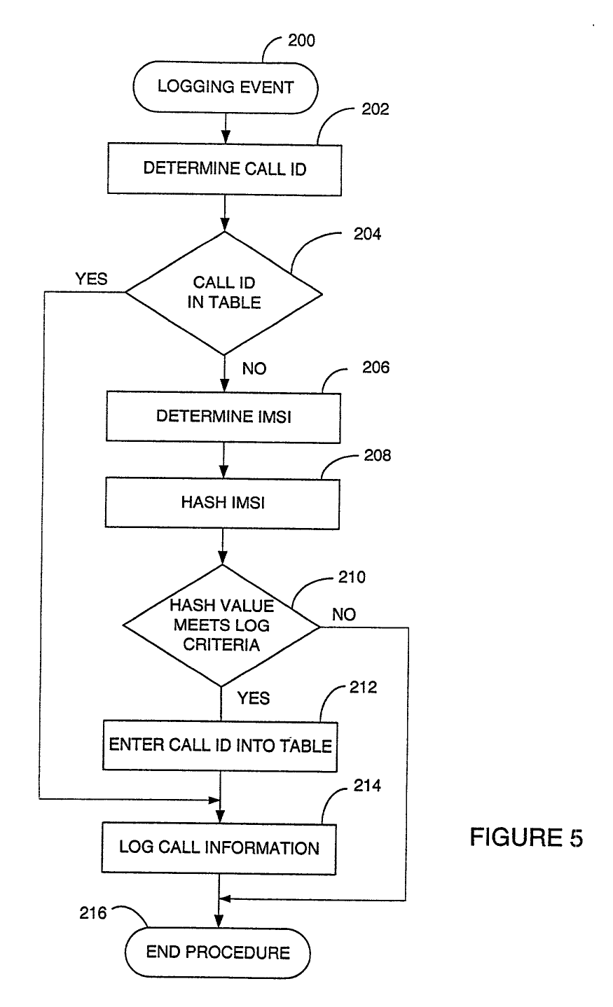

FIG. 5 is a flow diagram of another exemplary call logging procedure that “remembers” which calls to log and thus avoids repeatedly hashing the IMSI of the mobile terminal. In this embodiment, the processing entity 26 determines the call ID associated with the call (step 202) in response to a logging event (step 200) and compares the determined call ID to one or more stored call IDs associated with calls that are currently being logged (step 204). The call IDs for calls currently being logged may be stored, for example, in a call ID table as previously described. If the call ID associated with the call is entered in the call ID table, the processing entity 26 enters the required call information into the log (step 214) and the procedure ends (step 216). If the call ID is not entered in the call ID table, the processing entity 26 in that case determines the IMSI of the mobile terminal 12 associated with the call (step 206), hashes the IMSI (step 208), and compares the generated hash value with the predetermined criteria (step 210). If the generated hash value meets the predetermined criteria, the processing entity 26 determines the Call ID associated with the call, enters the call ID into the call ID table (step 212), and enters the required call information into the log (step 214) after which the procedure ends (step 216). If the generated hash value does not meet the predetermined criteria, the procedure ends (step 216) without entering any information into the log.

What is claimed is:

1. A method of logging call information in a mobile communication network, said method comprising:
hashing an identifier associated with a call to generate a hash value; and
logging call information concerning said call if said hash value meets a predetermined criteria.

2. The method of claim 1 wherein hashing said identifier to generate a hash value and logging call information concerning said call is performed by a single processing entity within said network.

3. The method of claim 1 wherein hashing said identifier to generate a hash value and logging call information concerning said call is performed by different processing entities within said network.

4. The method of claim 1 wherein logging call information associated with said call is performed by a central processor for a plurality of processing entities within said network.

5. The method of claim 1 wherein logging call information associated with said call is performed separately by two or more processing entities within said network.

6. The method of claim 1 further comprising storing an identifier associated with said call if said hash value meets said predetermined criteria and thereafter logging call information for said call based on said stored identifier.

7. The method of claim 6 wherein said stored identifier comprises a call identifier associated with said call.

8. The method of claim 6 wherein said stored identifier comprises a mobile terminal identifier for a mobile terminal associated with said call.

9. The method of claim 6 further comprising deleting said stored identifier when the corresponding call is terminated.

10. The method of claim 1 wherein said identifier comprises a call identifier associated with said call.

11. The method of claim 1 wherein said identifier comprises a mobile terminal identifier for a mobile terminal associated with said call.

12. The method of claim 1 wherein said identifier is the Knuth algorithm.

13. The method of claim 1 wherein said call information is logged if said hash value is less than a reference value.

14. The method of claim 1 wherein said call information is logged if said hash value is greater than a reference value.

15. The method of claim 1 wherein said call information is logged if said hash value is equal to a reference value.

16. The method of claim 1 wherein said call information is logged if said hash value is in a predetermined range.

17. A base station controller comprising:
one or more processing entities for processing calls;
a logging function associated with one or more of said processing entities for logging call information associated with selected calls, said logging function operative to:
hash an identifier associated with a call to generate a hash value; and
log call information associated with said call if said hash value meets a predetermined criteria.

18. The base station controller of claim 17 wherein said logging function is distributed among two or more processing entities.

19. The base station controller of claim 18 wherein a first processing entity includes code for hashing said identifier associated with said call and a second processing entity includes code for logging said call information if said identifier meets said predetermined criteria.

20. The base station controller of claim 18 wherein each processing entity includes code for hashing said identifier and logging call information associated with said call if said generated hash value meets said predetermined criteria.

21. The base station controller of claim 17 wherein said base station controller further includes a central network management module connected to each said processing entity, and wherein said logging function resides in said central network management module.

22. The base station controller of claim 17 further comprising memory for storing identifiers associated with calls that are being logged, and wherein said logging function logs call information for calls corresponding to said identifiers stored in said memory.

23. The base station controller of claim 22 wherein said stored identifier comprises a mobile terminal identifier for a mobile terminal associated with said call.

24. The base station controller of claim 22 wherein said stored identifier comprises a call identifier associated with said call.

25. The base station controller of claim 22 further including a code module for storing and deleting identifiers in said memory.

26. The base station controller of claim 17 wherein said identifier comprises a mobile terminal identifier for a mobile terminal associated with said call.

27. The base station controller of claim 17 wherein said identifier comprises a call identifier associated with said call.

28. The base station controller of claim 17 wherein said logging function uses the Knuth algorithm to hash said identifiers.

29. The base station controller of claim 17 wherein said logging function logs said call information if said hash value is less than a predetermined value.

30. The base station controller of claim 17 wherein said logging function logs said call information if said hash value is greater than a predetermined value.

31. The base station controller of claim 17 wherein said logging function logs said call information if said hash value is equal to a predetermined value.

32. The base station controller of claim 17 wherein said logging function logs said call information if said hash value is in a predetermined range.

33. A communication network comprising:
a plurality of base transceiver stations for communicating with mobile terminals;
a base station controller associated with said base transceiver stations, said base station controller comprising one or more processing entities for processing calls, and a logging function associated with one or more of said processing entities for logging call information associated with selected calls; and
wherein said logging function is operative to hash an identifier associated with said call to generate a hash value, and log call information associated said call if said hash value meets a predetermined criteria.

34. The base station controller of claim 33 wherein said logging function is distributed among two or more processing entities.

35. The base station controller of claim 34 wherein a first processing entity includes code for hashing said identifier associated with said call and a second processing entity includes code for logging said call information if said identifier meets said predetermined criteria.

36. The base station controller of claim 34 wherein each processing entity includes code for hashing said identifier and logging call information associated with said call if said generated hash value meets said predetermined criteria.

37. The base station controller of claim 33 wherein said base station controller further includes a central network management module connected to each said processing entity, and wherein said logging function resides in said central network management module.

38. The base station controller of claim 33 further comprising memory for storing identifiers associated with calls that are being logged, and wherein said logging function logs call information for calls corresponding to said identifiers stored in said memory.

39. The base station controller of claim 38 wherein said stored identifier comprises a mobile terminal identifier for a mobile terminal associated with said call.

40. The base station controller of claim 38 wherein said stored identifier comprises a call identifier associated with said call.

41. The base station controller of claim 38 further including a code module for storing and deleting identifiers in said memory.

42. The base station controller of claim 33 wherein said identifier comprises a mobile terminal identifier for a mobile terminal associated with said call.

43. The base station controller of claim 33 wherein said identifier comprises a call identifier associated with said call.

44. The base station controller of claim 33 wherein said logging function uses the Knuth algorithm to hash said identifiers.

45 The base station controller of claim 33 wherein said logging function logs said information if said hash value is less than a predetermined value.

46. The base station controller of claim 33 wherein said logging function logs said call information if said hash value is greater than a predetermined value.

47. The base station controller of claim 33 wherein said logging function logs said call information if said hash value is equal to a predetermined value.

48. The base station controller of claim 33 wherein said logging function logs said call information if said hash value is in a predetermined range.
